(19) United States
(12) Patent Application Publication
(10) Pub. No.: US 2015/0021429 A1
(43) Pub. Date: Jan. 22, 2015

(54) Remote-Controlled Aerial Device Platform

(71) Applicant: OIC-GmbH, Remscheid (DE)

(72) Inventor: Robert Heinrich Kurt Reichert, Remscheid (DE)

(21) Appl. No.: 14/326,724

(22) Filed: Jul. 9, 2014

(30) Foreign Application Priority Data
Jul. 18, 2013 (DE) 102013107654.8

(51) Int. Cl. B64C 27/08; B64D 9/00; B64C 27/04

(52) U.S. Cl. CPC B64C 27/08; B64C 27/04; B64D 9/00
USPC 244/17.23; 244/17.11

(57) ABSTRACT

The invention relates to an aircraft (10) for conveying one or more recording apparatuses, such as recorders, sensors, cameras, infrared cameras, microphones or the like, through the air. For this purpose, the aircraft (10) has one or more rotors (11) which control the flight movement, as well as a holder (12) for the recording apparatus. Moreover, a framework (13) is provided, on which all of the elements can be attached directly or indirectly. The invention now proposes that the framework (13) includes a body (20) with at least four arms (21) bent inward (24), at the ends (22) of which in each case at least one rotor (11) is arranged. Moreover, a bridge (30) is provided which, at its first end (31), comprises a holder (12) for the recording apparatus, wherein a counterweight (34) is provided at its second end (32). The bridge (30) is gimbaled with its center-of-gravity axis (33) via a central module (40) on the center-of-gravity axis (23) of the body (20) (FIG. 1).

### CROSS REFERENCE APPLICATIONS

This application claims the benefit of German Application No. 10 2013 107 654.8 filed Jul. 18, 2013, which is incorporated herein by reference for all purposes.

### BACKGROUND

The disclosure relates to an aircraft for conveying one or more recording apparatuses, such as recorders, sensors, cameras, infrared cameras, microphones or the like, through the air. This aircraft comprises a recording apparatus in the broader sense. This includes recorders, cameras, infrared cameras, sensors, microphones and the like. The term recorder here must be given a broad meaning. The recording apparatuses can save the recorded images, sounds or other parameters internally on a data support, or transmit them directly, preferably by wireless transmission, for example, via a radio frequency or also via other common wireless transmission systems, such as WLAN or Bluetooth, to a receiver apparatus.

Such aircraft have multiple uses, for example, in aerial photography of landscapes, objects or also moving scenes using a camera. It is important here for the aircraft to be as small and maneuverable as possible, and for the image recorded by a camera to be as stable as possible and not to be blurred in case of wind or air currents.

The foregoing example of the related art and limitations related therewith are intended to be illustrative and not exclusive. Other limitations of the related art will become apparent to those of skill in the art upon a reading of the specification and a study of the drawings.

### SUMMARY

The aim of the invention therefore is to provide an aircraft that is as light-weight as possible but that nevertheless provides a stable mount for the recording apparatus, for example, to generate a stable camera image by means of a camera carried along.

The framework of the aircraft includes a body with at least four arms bent inward, at the ends of which in each case at least one rotor, such as a propeller, is arranged. It is also possible to provide more than one rotor per arm. Advantageously, an equal number of rotors is arranged on each arm. Moreover, the framework includes a bridge on the first end of which a holder for the recording apparatus is arranged, while a counterweight is provided on the second end of the bridge. The bridge is gimbaled with its center-of-gravity axis via a central module on the center-of-gravity axis of the body. As a result of the center-of-gravity axes of the bridge and of the body being mutually aligned, a simpler orientation of the bridge and thus of the recording apparatus is possible. Due to the gimbal support of the bridge via the central module, the body can move nearly independently of the bridge, so that the holder and therefore the recording apparatus remain in a stable position. Here it is possible for the aircraft itself to be controlled by radio; however, it is explicitly included that the aircraft is already provided beforehand with a permanently stored flight route which is flown by the aircraft. In addition, a kind of autopilot can also be connected, which orients itself based on the environmental circumstances and parameters, and thus determines an individual flight route for the aircraft.

The above-mentioned capability can be further promoted in that, on the central module, compensation elements, such as servomotors, are provided, which counteract the transfers of motion of the body to the bridge, so that the bridge is always kept in its zero position. As a result, a uniform recording of the recording apparatus is made possible, for example, a stable image of a camera. Forces acting on the bridge from the outside can thus be compensated. Both rotation movements or vibrations generated by the rotor motions as well as other influences, such as air currents, winds or the like, for example, can be compensated accordingly.

In order to implement the most light-weight possible construction of the aircraft, it is advantageous to design the central module in a sufficiently stable manner so that it can absorb all the stresses that act on the body or the bridge. Here, stresses here cover stresses in the traction direction and compression direction as well as torsional forces. If the body and the bridge are designed so that such stresses can be dissipated in the direction of the central module, then it is possible to design these two components so that they are very low-weight, since the stresses can be absorbed via the central module. The design of this central module is then appropriately stable.

In one of the depicted embodiments the counterweight consists of accumulator batteries. These accumulator batteries are used as energy source for the rotors and also optionally for other elements, such as, for example, the servomotors used as compensation elements. It is also possible to provide these accumulator batteries as energy source for the recording apparatus.

Moreover, it is preferable for the weight of the counterweight to be adaptable. In that case, the counterweight can be adapted to the weight of the recording apparatus(s). Therefore, an individual aircraft can be designed for different recording apparatuses or for a different number of recording apparatuses. In order to keep the bridge, on which the holder for the recording apparatus(s) is arranged, in its zero position, it is then advantageous to adapt the weight of the counterweight.

In a depicted embodiment, specific accumulator batteries are used. They are used as counterweight. In order to adapt the total weight of the counterweight, additional accumulator batteries can be added or individual accumulator batteries can also be removed again. In the case of this specific type of accumulator batteries employed, the total voltage remains the same, while the total weight of the counterweight is changeable. Thus, it is only necessary to provide a number of accumulator batteries to then form the counterweight, which are adapted to the specific application case or the specific recording apparatus, so that the counterweight approximately matches the weight of the recording apparatus.

Moreover, it is preferable for the rotors to be arranged as a result of the shape of the arms inside of the clear width of the body. As a result, the rotors are so to speak enclosed by a cage formed by the arms. In this way, it is hardly possible for injuries or accidents or damage to the rotors to occur.

The aircraft or the rotors are protected from the surroundings, without negative effect on the airworthiness or power of flight. In addition, it is possible to provide arms that have a relatively large total length but are nevertheless compact due to the curvature. The larger total length is advantageous in order to compensate for vibrations of the rotors. A compact design is advantageous in order to obtain an aircraft which is as small as possible as far as the external dimensions are concerned, which is maneuverable and has a low weight.

In order to adapt or compensate for the exact position of the recording apparatus in all three directions of motion, it is preferable to provide compensation electronics in the area of the holder or of the recording apparatus. This allows an orientation of the recording apparatus in all three directions of motion, namely to the side, forward, backward, and also pivoted directions. In this way, the recording apparatus can be oriented for the actual case of use.

In an additional embodiment example, it is also possible to provide additional side propellers which allow a sideways movement of the aircraft. Said side propellers can be arranged on the long sides and/or on the corners of the body.

To be able to design the body and/or the bridge to be as light-weight as possible, these components can consist of a lattice construction. This lattice construction has the additional advantage that it offers only few surfaces of attack for winds or air currents, which otherwise can move an aircraft out its flight path. It is preferable to produce the body or the bridge entirely or partially from a plastic, since plastic is particularly light-weight.

Moreover, it is advantageous to produce the body and/or the bridge at least in some sections by means of a 3D printer. This 3D printer allows an individual manufacturing of different shapes and sizes. In addition, in a preferred embodiment example, the above-mentioned components entirely or partially have an organic shape. Such shapes are particularly stable. An organic shape is a shape found in nature, for example, as in the case of branches, trees, branch forks, bones, joints, spider webs, antlers and the like.

One possibility for the gimbal support of the bridge on the body in the central module is a ball bearing. Other forms of a gimbal support are naturally also possible.

Additional advantages and embodiments of the invention result from the following description, the dependent claims as well as the drawings. In the drawings, the aircraft according to the invention is represented in an embodiment example. In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 shows: an aircraft according to the invention in a top view,

FIG. 2 shows: the aircraft according to the invention of FIG. 1 in a side view,

FIG. 3 shows: the aircraft according to the invention of FIGS. 1 and 2 in a front view.

Before explaining the disclosed embodiment of the present invention in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

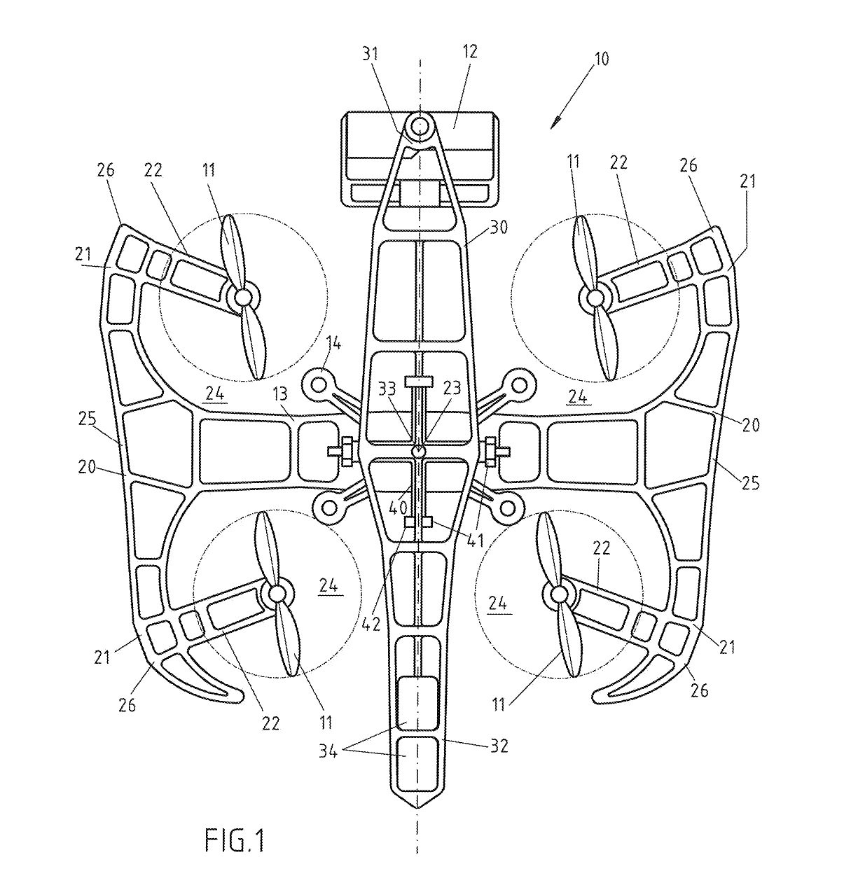

FIG. 1 shows an aircraft 10 according to the invention with a framework 13. A body 20 is provided, which has four arms 21 that are curved inward 24. On the one hand, this curvature has the advantage that the rotors 11 arranged at the ends 22 of the arms 21 are protected, since they are surrounded in many directions by the framework 13, so that the risk of accident decreases but also the risk of injuries of the rotors 11 decreases. On the other hand, there is also the advantage that a relatively long length of the arms 21 can be constructed in a very compact manner, as a result of which the aircraft 10 in terms of its outer dimensions can be kept very small. This length of the arms 21 is used to absorb and dissipate vibrations, which can occur due to the movement of the rotors 11, via the arms 21.

Both the bridge 30 and also the body 20 are designed as lattice constructions. This has the advantage that the two components can be designed so that they have a very low weight and also a small attack surface for air currents and winds. One can also see that the bridge 30 is arranged via a central module 40 on the body 20. The central module 40 here has compensation elements 41 which are here designed as servomotors 42.

Moreover, one can see that the bridge 30 has a holder 12 at its first end 31. Into this holder, one or more recording apparatuses that are not shown here can be introduced. At the second end 32, the bridge 30 has a counterweight 34. This counterweight consists preferably of accumulator batteries. The counterweight 34 is used for the purpose of keeping the bridge 30 balanced, when the holder 12 is loaded with one or more recording apparatuses.

Moreover, one can see that both the center-of-gravity axis 23 of the body 20 and also the center-of-gravity axis 33 of the bridge 30 are mutually aligned. At these center-of-gravity axes 23, 33, the two components 20, 30 are connected to one another via the central module 40, wherein the connection uses a gimbal support in order to allow as many degrees of freedom in the movement of the body 20 relative to the bridge 30 as possible.

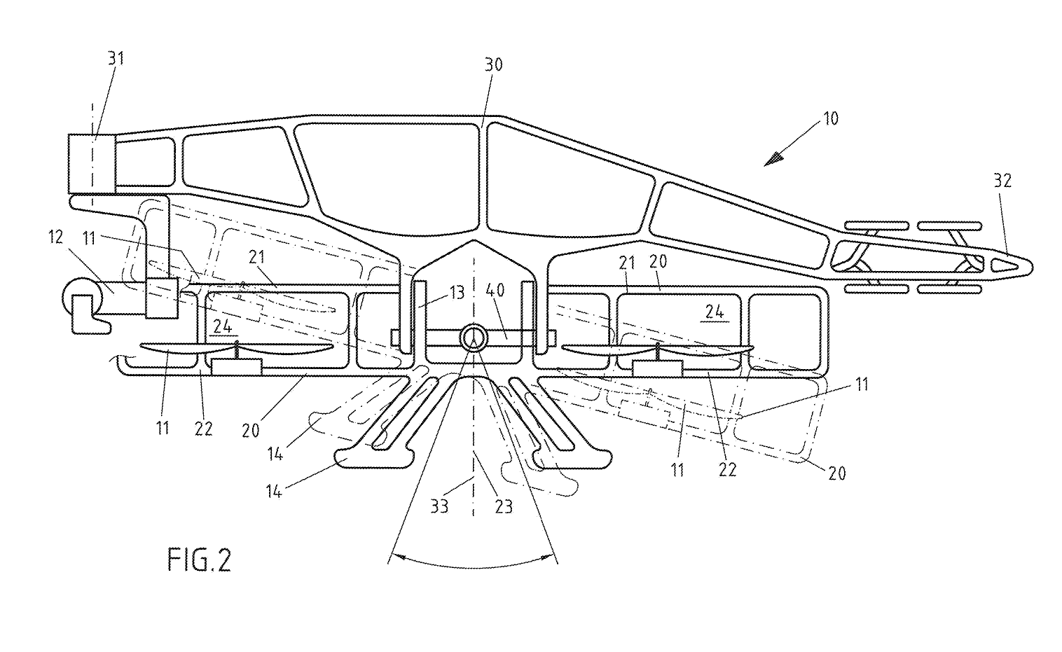

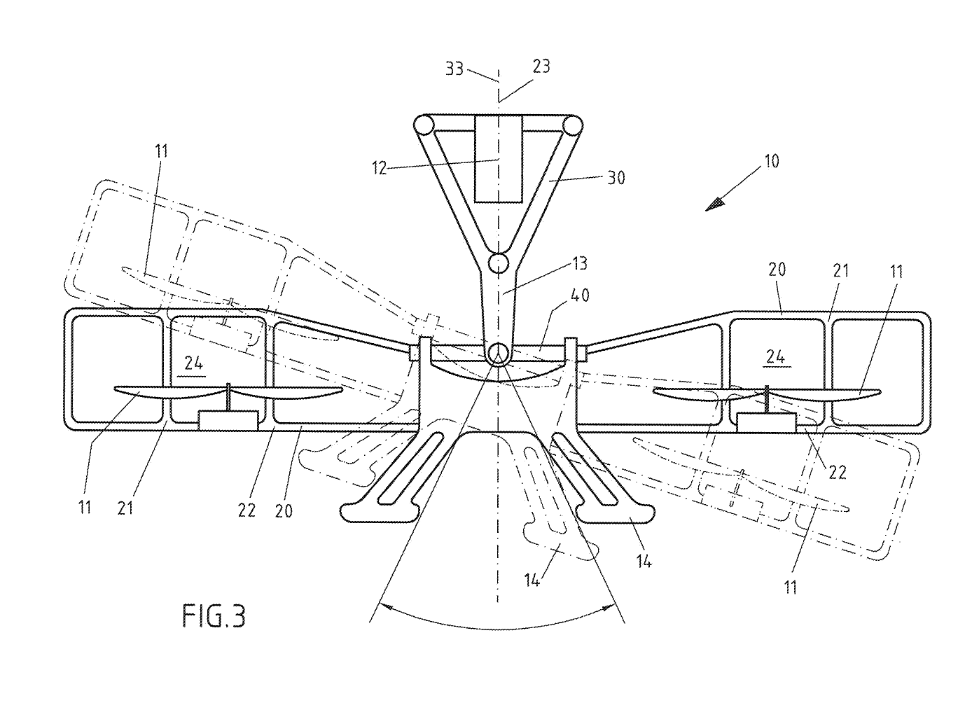

FIGS. 2 and 3 show the mode of operation of the aircraft 10 according to the invention, including in flight through air currents or when exposed to stresses from wind. One can see that, in the case of a pivoting of the body 20 in the direction of the arrow, for example, to compensate for air currents and winds, the central module 40 is in part pivoted along with it; however, the other part of the central module 40 together with the bridge 30 remains in the zero position. The pivoted position is represented by broken lines. As a result, it is possible to take very stable recordings, for example, image recordings with a recording apparatus which is arranged in the holder 12. For example, when sensors are used as recording apparatuses, deviations from measured values, which can be generated due to an unstable immobilization or unstable flight properties of the aircraft 10, are thus avoided.

Moreover, one can see in FIG. 2 that the bridge 30 has a curved design. This increases the stability, and as a result the construction of the bridge can be more light-weight. In addition, one can also see the bases 14, on which the aircraft 10 comes to stand, for example, during starting and landing, and naturally also for providing the holder 12 with a recording apparatus, for the replacement or the adaptation of the counterweight 34, for the storage of the aircraft 10 or the like.

Finally, it is also pointed out that the embodiments represented here are only embodiment examples of the invention. The invention is not limited to them. Rather, modifications and variations are also possible. In particular, the exact structure of the body, of the bridge and also of the central element can vary. The lattice construction of the body and of the bridge can have a structure other than the one represented here. For example, it can be designed to be clearly organic. A particular advantage of the invention, in addition to a good stabilization of the holder, is a very low weight of the aircraft, so that the accumulator batteries used are sufficient for a long flight duration. In addition, the aircraft can be made of nearly any material, in order to cope with different environmental conditions. Finally, the apparatus is designed to be sufficiently small and compact, and it is provided with protected rotors, so that in many countries no particular pilot's license is required for operating the aircraft.

### LIST OF REFERENCE NUMERALS

10 Aircraft
11 Rotor
12 Holder
13 Framework
14 Base
20 Body
21 Arm
22 End of 21
23 Center-of-gravity axis of 20
24 Inside of 20
25 Long side of 20
26 Corner of 20
30 Bridge
31 First end of 30
32 Second end of 30
33 Center-of-gravity axis of 30
34 Counterweight
40 Central module
41 Compensation element
42 Servomotor

1. An aircraft for conveying one or more recording apparatuses, such as recorders, sensors, cameras, infrared cameras, microphones or the like, through the air comprising:
one or more rotors which control the flight movement;
a holder for the recording apparatus;
a framework on which all of the elements can be attached directly or indirectly;
the framework further comprises a body with at least four arms bent inward, at least one rotor arranged at the ends of each arm;
the holder for the recording apparatus is arranged at a first end of a bridge, wherein a counterweight is provided at s second end of the bridge; and
the bridge is gimbaled with its center-of-gravity axis via a central module on the center-of-gravity axis of the body.

2. The aircraft of claim 1 wherein the central module has compensation elements such as servomotors, which ensure that the bridge is always kept in its zero position, in order to allow a steady recording of the recording apparatus.

3. The aircraft of claim 1 wherein the central module is designed to be sufficiently stable so that it can absorb all the stresses in the traction direction and compression direction as well as torsion forces applied to the body or the bridge.

4. The aircraft of claim 1 wherein the counterweight consists of accumulator batteries.

5. The aircraft of claim 1 wherein the weight of the counterweight is adaptable.

6. The aircraft of claim 4 wherein the accumulator batteries can be added to the counterweight or removed therefrom without changing the total voltage on the accumulator batteries, but with a change in the total weight of the counterweight.

7. The aircraft of claim 1 wherein the rotors as a result of the shape of the arms are arranged inside (24) of the clear width of the body.

8. The aircraft of claim 1 wherein compensation electronics is provided in the area of the recording apparatus and/or the holder, in order to compensate for the position of the recording apparatus in all three directions of movement.

9. The aircraft of claim 1 wherein additional side propellers are provided, which allow the sideways movement of the aircraft and which are arranged on the long sides or on the corners of the body.

10. The aircraft of claim 1 wherein the body and/or the bridge consist(s) of a lattice construction, preferably made entirely or partially of plastic.

11. The aircraft of claim 1 wherein the body and/or the bridge is/are printed at least in some sections and it/they preferably has/have entirely or partially an organic shape.

12. The aircraft of claim 1 wherein the gimbal support in the central module occurs by one or more ball bearings.

13. The aircraft of claim 1 wherein bases are provided, on which the aircraft can stand on the ground.
